(19) United States
(12) Patent Application Publication
(10) Pub. No.: US 2015/0200443 A1
(43) Pub. Date: Jul. 16, 2015

(54) FLIP-LOCK TYPE ELECTRICAL DEVICE

(71) Applicant: Quanta Computer Inc., Kuei Shan Hsiang (TW)

(72) Inventors: Wen-Yuan Lo, Kuei Shan Hsiang (TW); Hui Lin, Kuei Shan Hsiang (TW); Jui-Chun Jao, Kuei Shan Hsiang (TW); Hsiang-Yeh Cheng, Kuei Shan Hsiang (TW)

(73) Assignee: Quanta Computer Inc., Kuei Shan Hsiang (TW)

(21) Appl. No.: 14/284,260

(22) Filed: May 21, 2014

(30) Foreign Application Priority Data
Jan. 16, 2014 (TW) 103101569

(51) Int. Cl. H01Q 1/22

(52) U.S. Cl. CPC H01Q 1/2266

(57) ABSTRACT

A flip-lock type electrical device is provided. The flip-lock type electrical device includes a lid part which includes a metal part and a non-metal part, wherein the metal part includes a hinge cap, and one or a plurality of antennas, and one or a plurality of non-metal support material are configured in the hinge cape, and the hinge cape includes an antenna window, and wherein the antenna is grounded to the metal part, a main part, which includes a keyboard part and a base part, and a hinge part, configured to connect the lid part with the main part.

### CROSS REFERENCE TO RELATED APPLICATIONS

This Application claims priority of Taiwan Patent Application No. 103101569, filed on Jan. 16, 2014, the entirety of which is incorporated by reference herein.

### BACKGROUND OF THE INVENTION

1. Field of the Invention

The disclosure is related to antenna arrangement, and, more particularly, to the antenna arrangement for a flip-top type electrical device.

2. Description of the Related Art

Recently, because of the rapid development of wireless communications, portable devices such as smartphones, personal digital assistants (PDAs), and tablet PCs are widely available, and have become more and more technically advanced and multifunctional. Due to the increased convenience and functionality of the devices, these devices have become necessities of life.

However, because the electrical devices comprise more and more elements, for antenna-arrangement technology, all of the related parameters of the disposition of the antennas must be considered to achieve desired function and performance Take a notebook for example; the built-in antenna may usually be configured in the circumference of the screen. Therefore, the radiation of the antennas may be designed and arranged in the circumference of the screen.

However, with the advancement of wireless transmission functions built into the notebook or smartphone, antennas for any operation frequency are configured therein. Therefore, antennas for WLAN, Long Term Evolution (LTE), WiMAX, Bluetooth, Near Field Communication, etc., are all configured in the electrical devices. Otherwise, antennas are usually manufactured by Laser Direct Structuring (LDS) technology to achieve better throughput. In Laser Direct Structuring technology, firstly, an electrical circuit of an antenna is burned on a case or mechanisms by a 3D infrared laser apparatus. Then, a conduct metal is electroplated on different materials of the case or mechanisms, wherein the conduct metal has a high adhesive force through electroplating. However, if the antennas are manufactured by Laser Direct Structuring (LDS) technology, additional costs will be incurred. Therefore, it is desirable to increase the wireless communication performance of the antenna under the consideration of antenna configuration and the cost.

### BRIEF SUMMARY OF THE INVENTION

An embodiment of the invention provides a flip-lock type electrical device is provided. The flip-lock type electrical device includes a lid part which includes a metal part and a non-metal part, wherein the metal part includes a hinge cap, and one or a plurality of antennas, and one or a plurality of non-metal support material are configured in the hinge cape, and the hinge cape includes an antenna window, and wherein the antenna is grounded to the metal part; a main part, which includes a keyboard part and a base part; and a hinge part, configured to connect the lid part with the main part.

### BRIEF DESCRIPTION OF THE DRAWINGS

The invention will become more fully understood by referring to the following detailed description with reference to the accompanying drawings, wherein:

FIG. 1 is schematic diagram illustrating the flip-lock type electrical device 100 according to an embodiment of the invention;

FIG. 2 is schematic diagram illustrating the ground connection of the antenna 114 according to an embodiment of the invention;

FIG. 3 is schematic diagram illustrating the configuration of the antenna 114 according to an embodiment of the invention.

### DETAILED DESCRIPTION OF THE INVENTION

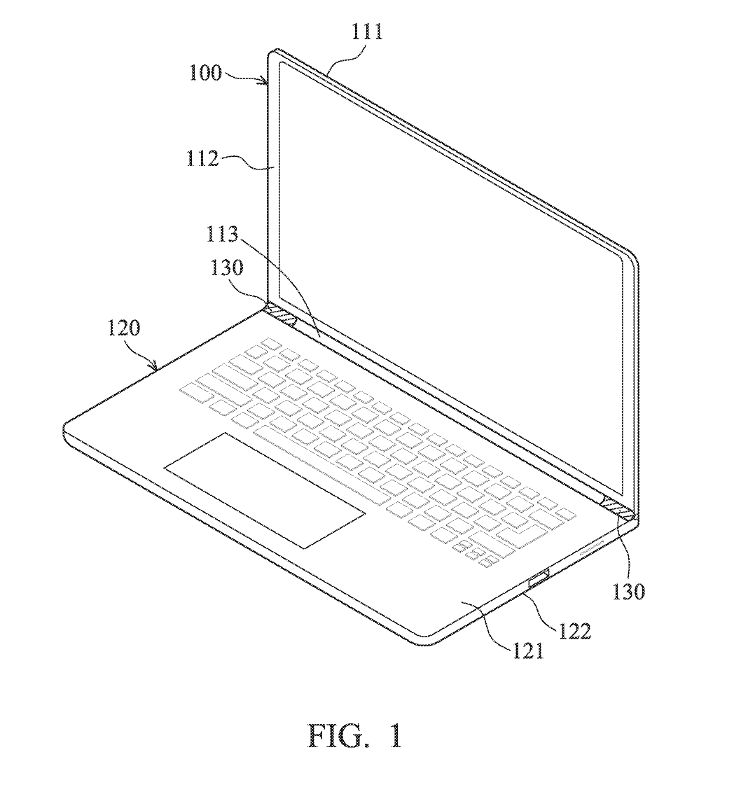

FIG. 1 is schematic diagram illustrating the flip-lock type electrical device 100 according to an embodiment of the invention. As shown in FIG. 1, the flip-lock type electrical device 100 comprises a lid part 110, a main part 120 and a hinge part 130. The flip-lock type electrical device 100 may be a notebook, a smartphone, or a personal digital assistant (PDA), etc., but it is to be understood that the invention is not limited thereto. Those who are skilled in this technology can apply the flip-lock type electrical device 100 in computer-system configurations such as hand-held devices, portable devices, microprocessor-based or programmable consumer electronics and other similar devices. Note that the flip-lock type electrical device 100 in the embodiments of the invention is regarded as a notebook, and it is to be understood that the invention is not limited thereto.

In an embodiment of the invention, the lid part 110 includes a metal part 111 and a non-metal part 112. The metal part 111 is regarded as a cover of the flip-lock type electrical device 100 and the material of the metal part 111 is a metal material. The non-metal part 112 is regarded as the rack of the flip-lock type electrical device 100 for embedding the screen (e.g. a liquid crystal screen or a touch screen), and the material of the non-metal part 112 is a non-metal material. The main part 120 includes a keyboard part 121 and a base part 122. The keyboard part 121 is configured for the keyboard or inputting device of the flip-lock type electrical device 100, namely the upper half of the main part 120. The base part 122 is regarded as the base of the flip-lock type electrical device 100, namely the lower half of the main part 120. The hinge part 130 is configured to connect the lid part 110 with the main part 120. Taking a notebook for example, the metal part 111 of the flip-lock type electrical device 100 is regarded as the A element (LCD COVER LCD). The non-metal part 112 is regarded as the B element (LCD BEZE LCD). The keyboard part 121 is regarded as the C element (TOP CASE). The base part 122 is regarded as the D element (BOTTOM CASE). The A-D elements of the notebook are common terminology for those who are skilled in this technology.

The metal part 111 of the lid part 110 includes a hinge cap 113. One or a plurality of antennas, and one or a plurality of non-metal support-materials is configured in the hinge cap 113. Each of the antennas is configured in a non-metal support-material. Note that in the Figures, an antenna 114 and a non-metal support-material 115 are presented only for simplicity, and it is to be understood that the invention is not limited thereto. Those who are skilled in this technology can apply other antennas and non-metal support-materials according to the requirements of flip-lock type electrical device 100. The antenna 114 may be a WLAN antenna, a LTE antenna, a WiMAX antenna, a Bluetooth antenna or an NFC antenna, etc. to support different wireless communications technology. The material of the non-metal support-material 115 may be rubber, plastic or other non-metal materials.

In an embodiment of the invention, the antenna 114 is configured on the non-metal support-material 115, and the angle of the antenna 114 may be adjusted by the non-metal support-material 115 according different manufacturing requirements of the flip-lock type electrical device 100 to achieve the best coverage and radiation pattern of the antenna. Traditionally, the antenna 114 may be configured in the keyboard part 121, the base part 122 or the hinge part 130. However, because system noise and panel noise may affect throughput when the radiating and conducting method is applied, the antenna 114 configured in the keyboard part 121, the base part 122 or the hinge part 130 may have more noises. Therefore, even if the radiation pattern of the antenna 114 is satisfactory, the throughput of the antenna 114 may still be poor because of too much noise. Therefore, in the embodiment of the invention, the antenna 114 is configured in the hinge cap 113 and the angle of the antenna 114 can be adjusted by the non-metal support-material 115 to reduce system noise and panel noise for the antenna 114.

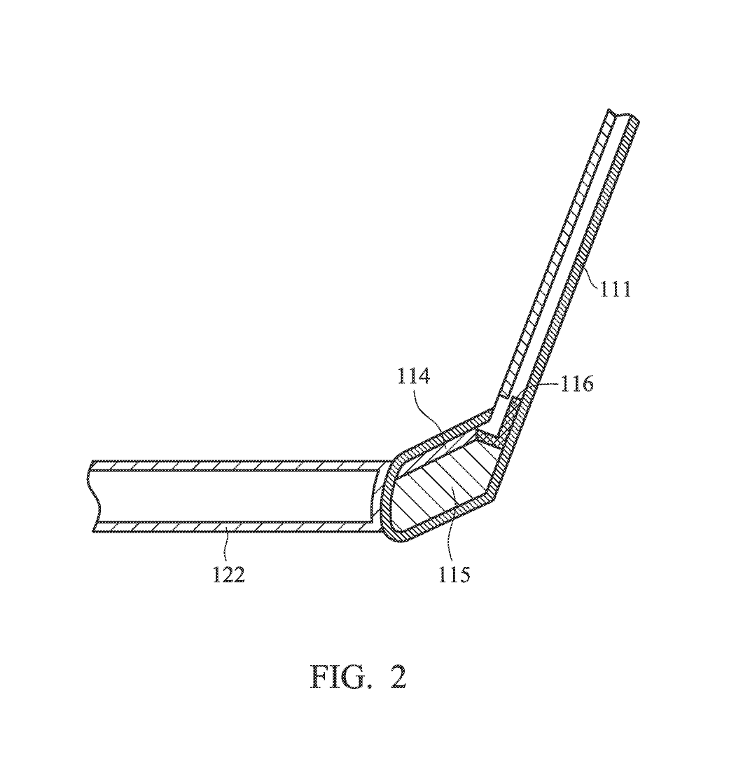

FIG. 2 is schematic diagram illustrating the ground connection of the antenna 114 according to an embodiment of the invention. As shown in FIG. 2, in an embodiment of the invention, the antenna 114 is grounded to the metal part 111 by a cooper foil 116. Traditionally, the antenna 114 is grounded to the base part 122 by a cooper foil 116. Therefore, the radiation pattern of the antenna 114 is horizontal polarization. However, the wireless access point (AP) is usually disposed higher than the flip-lock type electrical device 100, therefore, the radiation pattern of the access point is vertical polarization. Because the radiation pattern of the antenna 114 and access point are different, when the antenna 114 receives the signal from the access point, the transmission performance of the signal may be poor. Therefore, compared with the antenna 114 grounded to the base part 122, the radiation pattern of the antenna 114 grounded to the metal part 111 is vertical polarization. Therefore, the radiation pattern of the antenna 114 grounded to the metal part 111 can match with the radiation pattern of the access point to achieve better transmission performance.

In an embodiment of the invention, the metal part 111 further includes an antenna window. The antenna window may be configured in the hinge cap 113. The antenna window is a plastic separable-element. Therefore, the antenna window can be separated from the metal part 111. Under the premise that Electromagnetic Disturbance (EMI) can be satisfied, the area of the antenna window is determined according different manufacturing requirements of the flip-lock type electrical device 100.

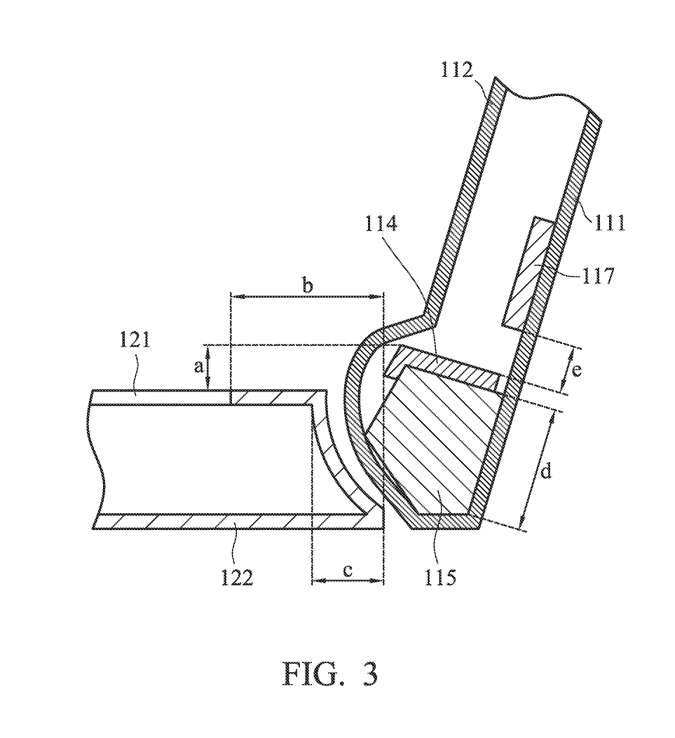

FIG. 3 is schematic diagram illustrating the configuration of the antenna 114 according to an embodiment of the invention. As shown in FIG. 3, configuration parameters of the antenna 114 need to satisfy some configuration parameters of the flip-lock type electrical device 100 to achieve better transmission performance.

As shown in FIG. 3, in an embodiment of the invention, the position where the antenna 114 is configured is higher than position of the keyboard part 121 by a distance value “a”. In an embodiment of the invention, the distance value “a” is approximately 2 millimeters.

As shown in FIG. 3, in an embodiment of the invention, the antenna 114 is configured from the keyboard part 121 by a distance value “b”. In an embodiment of the invention, the distance value “b” is approximately 5 millimeters.

As shown in FIG. 3, in an embodiment of the invention, the antenna 114 is configured from the base part 122 by a distance value “c”. In an embodiment of the invention, the distance value “c” is approximately 3 millimeters.

As shown in FIG. 3, the position where the antenna 114 is configured is higher than position of the hinge part 130 by a distance value “d”. In an embodiment of the invention, the distance value “d” is approximately 1-3 millimeters.

As shown in FIG. 3, the metal part 111 further includes a printed circuit board (PCB) 117, and the antenna 114 is configured from the printed circuit board 117 by a distance value “e”. In an embodiment of the invention, the distance value “e” is approximately 3 millimeters.

According to the configuration of the antenna 114 of the flip-lock type electrical device 100 in the embodiments of the invention, the antenna 114 can achieve better coverage and radiation patterns to increase the transmission performance of the antenna 114 by being configured in the hinge cap 113 and through angle and distance value adjustments. In addition, the embodiments of the invention can be accomplished with standard antennas without requiring an LDS antenna. Therefore, high antenna costs can be avoided.

Reference throughout this specification to “one embodiment” or “an embodiment” means that a particular feature, structure, or characteristic described in connection with the embodiment is included in at least one embodiment of the invention, but do not denote that they are present in every embodiment. Thus, the appearances of the phrases “in one embodiment” or “in an embodiment” in various places throughout this specification do not necessarily refer to the same embodiment of the invention. Furthermore, the particular features, structures, or characteristics may be combined in any suitable manner in one or more embodiments. Various additional layers and/or structures may be included and/or described features may be omitted in other embodiments.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents. In addition, reference numbers may be repeated throughout the embodiments, but they do not require that feature(s) of one embodiment apply to another embodiment, even if they share the same reference number.

What is claimed is:

1. A flip-lock type electrical device, comprising:
a lid part, including a metal part and a non-metal part, wherein the metal part includes a hinge cap, and one or a plurality of antennas, and one or a plurality of non-metal support-materials are configured in the hinge cap, and the hinge cap includes an antenna window, and wherein the antenna is grounded to the metal part;
a main part, including a keyboard part and a base part; and
a hinge part, configured to connect the lid part with the main part.

2. The flip-lock type electrical device of claim 1, wherein the antenna is configured on the non-metal support-material.

3. The flip-lock type electrical device of claim 2, wherein an angle of the antenna is adjusted by the non-metal support-material.

4. The flip-lock type electrical device of claim 1, wherein a position where the antenna is configured is higher than the position of the keyboard part by a distance value.

5. The flip-lock type electrical device of claim 1, wherein the antenna is configured from the keyboard part by a distance value.

6. The flip-lock type electrical device of claim 1, wherein the antenna is configured from the hinge part by a distance value.

7. The flip-lock type electrical device of claim 1, wherein a position where the antenna is configured is higher than the position of the keyboard part by a distance value that.

8. The flip-lock type electrical device of claim 1, wherein the metal part further includes a printed circuit board and the antenna is configured from the printed circuit board a distance value.

9. The flip-lock type electrical device of claim 1, wherein the antenna is grounded by a cooper foil.

10. The flip-lock type electrical device of claim 1, wherein the antenna window is a plastic separable-element.
